(19) United States
(12) Patent Application Publication
(10) Pub. No.: US 2013/0259589 A1
(43) Pub. Date: Oct. 3, 2013

(54) TAPPING APPARATUS, ACCESSORY, AND USE THEREOF

(71) Applicants: Peter Brown, Thornton (CA); Scott Trace, Elmvale (CA)

(72) Inventors: Peter Brown, Thornton (CA); Scott Trace, Elmvale (CA)

(73) Assignee: HONDA MOTOR CO., LTD., Tokyo (JP)

(21) Appl. No.: 13/433,699

(22) Filed: Mar. 29, 2012

(51) Int. Cl. B23G 1/48; B23G 1/02

(52) U.S. Cl. 408/111; 408/239 R; 408/241 G

(57) ABSTRACT

Described are various embodiments of a tapping apparatus and accessory for tapping a hole. The apparatus generally comprises a body defining a longitudinal cavity therein for longitudinal alignment with the hole. A tap assembly comprises opposed tapping and driving elements engaged within the cavity to rotate in longitudinal alignment therewith and to be longitudinally guided thereby in operation.

### FIELD OF THE DISCLOSURE

The present disclosure relates generally to tools and related apparatus, and in particular, to a tapping apparatus, accessory, and use thereof.

### BACKGROUND

Various handheld and powered tapping tools and accessories are known in the art to tap or otherwise provide for the inner threading of a hole or bore. U.S. Pat. Nos. 4,040,328; 4,799,832; 5,507,608; 5,573,357; 6,997,654; 5,209,616; 6,569,022; 5,354,154 provide examples of such tools and accessories. Tap guides are also known to provide a guide hole or tube for guiding a tap orientation or depth, such as described in U.S. Pat. Nos. 5,415,502 and 4,355,931.

Other tap-related tools have been proposed, for example, wherein a tap can be used to engage and then remove an injector sleeve from the cylinder head of a diesel engine block, such as described in U.S. Patent Application Publication No. 2010/0095500.

While the above provide different examples of tapping tools and accessories, these tools generally suffer from one or more drawbacks, such as being difficult or cumbersome to use, particularly where speed, efficiency and/or reproducibility may be of importance; being limited in the speed at which they can be operated; providing limited stability; or again commonly resulting in misalignments and thus poor finishes, to name a few. Therefore, there remains a need for a tapping apparatus and/or accessory that overcomes some of the drawbacks of known apparatus, or at least, provides the public with a useful alternative.

This background information is provided to reveal information believed by the applicant to be of possible relevance to the present invention. No admission is necessarily intended, nor should be construed, that any of the preceding information constitutes prior art against the invention(s).

### SUMMARY

An object of the invention is to provide a tapping apparatus and/or accessory that overcomes some of the drawbacks of known apparatus, or at least, provides the public with a useful alternative. In accordance with one embodiment of the invention, there is provided a tapping apparatus for tapping a hole defined within a structure, comprising: a body defining a longitudinal cavity therein and having an alignment portion defined at an extremity thereof for engaging the structure to be tapped to align said cavity with the hole; and a tap assembly comprising opposed tapping and driving elements engaged within said cavity to rotate in longitudinal alignment therewith and to be longitudinally guided thereby; wherein, upon driving said driving element, said tapping element is driven to engage the hole through said alignment portion and thereby advance within said cavity via said engagement therewith to maintain alignment with the hole.

In accordance with another embodiment, there is provided a tapping apparatus for tapping a hole defined within a structure, comprising: a body defining a longitudinal cavity therein for longitudinal alignment with the hole; and a tap assembly comprising a tapping element and an opposed driving element for rotationally driving same, and a coupling element coupling said tapping element within said cavity to rotate in longitudinal alignment therewith and to be longitudinally guided thereby in operation.

In accordance with another embodiment, there is provided a tapping accessory for use with a drivable tap in tapping a hole defined within a structure, the accessory comprising: a body defining a longitudinal cavity therein for longitudinal alignment with the hole, and a coupling element for coupling said tapping element within said cavity to rotate in longitudinal alignment therewith and to be longitudinally guided thereby in operation.

Other aims, objects, advantages and features of the invention will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a cross-sectional view of a tapping apparatus aligned for operation on a hole defined within a protruding structure, in accordance with one embodiment of the invention;

FIG. 2 is a cross-sectional view of the tapping apparatus of FIG. 1, once engaged to the protruding structure;

FIG. 3 is a cross-sectional view of the tapping apparatus of FIG. 1, illustrating a tapping operation thereof on the hole;

FIG. 4 is a cross-sectional view of the tapping apparatus of FIG. 1, illustrating a retraction thereof from the tapped hole; and

FIG. 5 is a cross-sectional view of the tapping apparatus of FIG. 1, once disengaged from the protruding structure.

### DETAILED DESCRIPTION

With reference to the disclosure herein and the appended figures, a tapping apparatus, accessory, and method of use thereof, will now be described, in accordance with different embodiments of the invention.

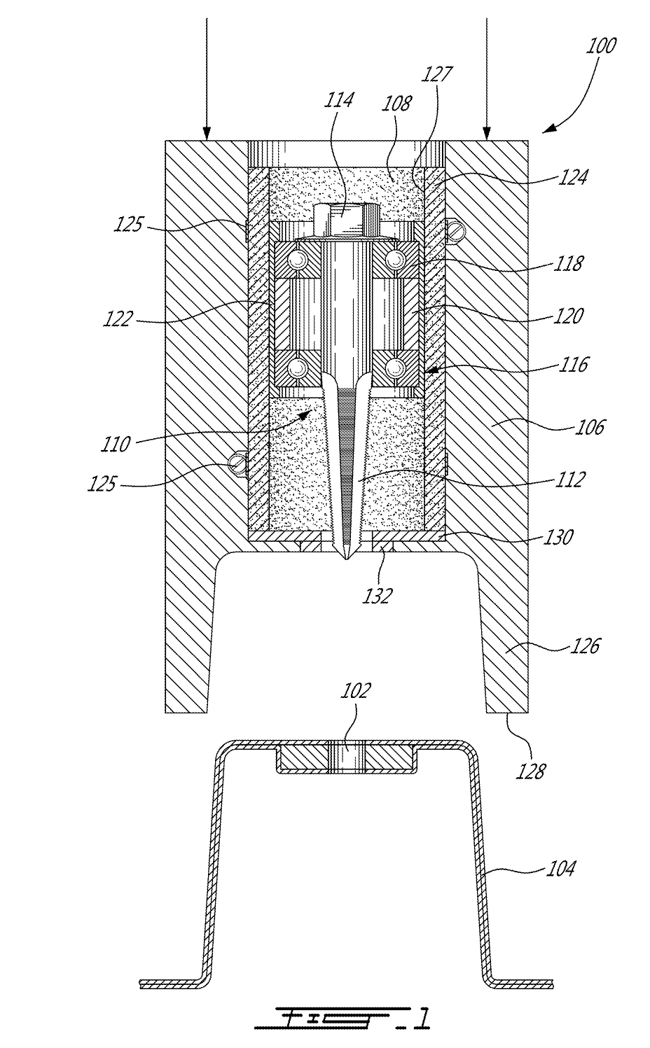

With reference to FIGS. 1 to 5, and in accordance with one embodiment of the invention, a tapping apparatus, generally referred to using the numeral 100, is provided for tapping a hole 102, for example as defined within a structure, such as protruding structure 104. The apparatus generally comprises a body 106 defining a longitudinal cavity 108 therein for longitudinal alignment with the hole 102. A tap assembly, generally referred to using the numeral 110, comprises opposed tapping and driving elements (112 and 114, respectively) engaged within the cavity 108 to rotate in longitudinal alignment therewith and to be longitudinally guided thereby in operation.

In this embodiment, the apparatus 100 further comprises one or more coupling elements for coupling the tapping element 112 within the cavity 108. For example, one or more bearings, such as rotational bearing assembly 116, may be provided as coupling element to improve or enhance rotation of the tapping element 112 within the cavity 108. Bearing assembly 116 illustratively comprises two sealed high-speed bearings 118, longitudinally spaced apart by spacer 120 and encased within casing 122 (e.g. a Delrin™ plastic sleeve in one specific example). The tapping element 112 is effectively fitted or otherwise engaged within the bearing assembly 116, with the driving element 114 resting thereon or otherwise extending outwardly therefrom to be driven, and thereby drive the tapping element 112 to rotate smoothly via bearings 118. It will be appreciated that different bearing types and configurations may be considered herein to provide similar effects, without departing from the general scope and nature of the present disclosure.

To further improve or enhance operation, the apparatus 100 may further comprise a linear bearing 124 as a further coupling element, thus facilitating guided longitudinal displacement of the tapping element 112 within the cavity 108. For example, in the illustrated embodiment, an oil less linear bearing 124 is provided, shaped and maintained in position by two hose clamps 125, or the like, to guide longitudinal displacement of the tapping element 112 within the cavity 108 via a sliding motion of the bearing assembly casing 122 against the inner surface 127 of the oil less bearing 124. Again, different types of linear bearings may be considered herein to provide similar results, as can alternative constructions and/or materials used, without departing from the general scope and nature of the present disclosure.

In this particular embodiment, the apparatus 100 further comprises an alignment portion 126, in this case defined integrally at an extremity 128 of the body 106, for cooperative engagement with the structure 104. In this particular example, the body may consist of a urethane mold or the like in which the tap assembly 110 may be embedded in operative engagement. Given the generally protruding nature of structure 104, the engagement portion may be cooperatively shaped and sized for mating engagement with the structure 104 and thereby align the cavity 108 with the hole 102, i.e. align respective longitudinal axes of the cavity 108 and hole 102. In such examples, the alignment portion may comprise one or more engagement structures extending longitudinally from the body 106, such as one or more legs or walls, or again a cup-like structure, shaped and/or curved to correspond substantially with a shape and size of the structure 104. As will be appreciated by the skilled artisan, different shapes, sizes and structure profiles may be considered herein, as can different approaches to providing a mating or otherwise corresponding engagement between the apparatus' alignment portion and the structure. For example, a recessed structure may be similarly engaged by an appropriately shaped alignment portion, whereby the alignment portion provides mating engagement within the recessed structure in aligning the apparatus with a hole to be tapped defined within this recessed structure. These and other such examples are thus intended to fall within the general scope and nature of the present disclosure.

To limit a longitudinal displacement of the tap assembly 110, the cavity 108 may be capped or otherwise enclosed. In this example, a first washer 130 sized to encase the linear bearing 124, and a second washer 132 resting thereon and fitted within a corresponding opening of the body 106, both provide aligned inner openings for the free passage of the working tip of the tapping element 112 therethrough to engage the hole 102 in operation, while limiting a longitudinal travel of the tap assembly.

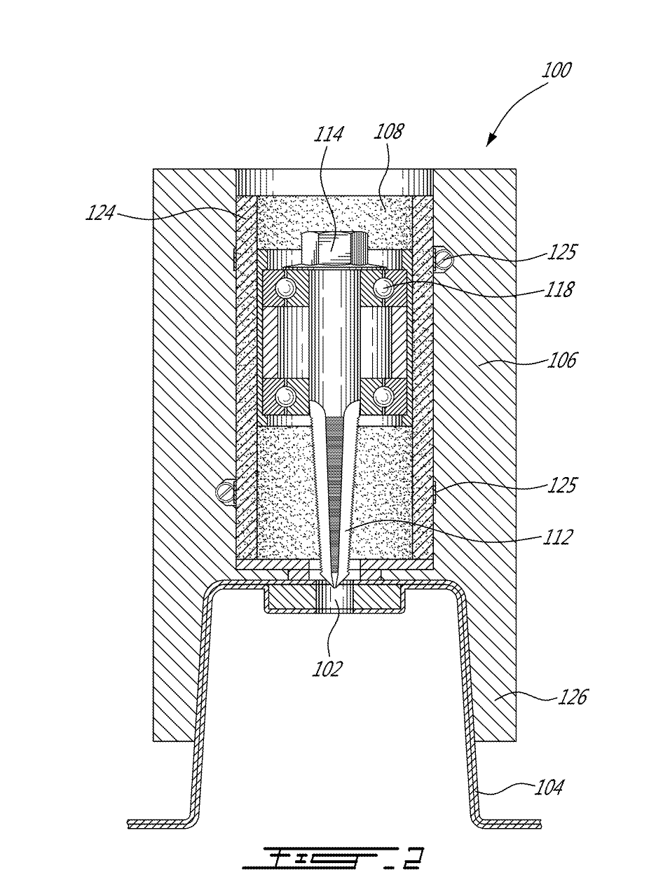

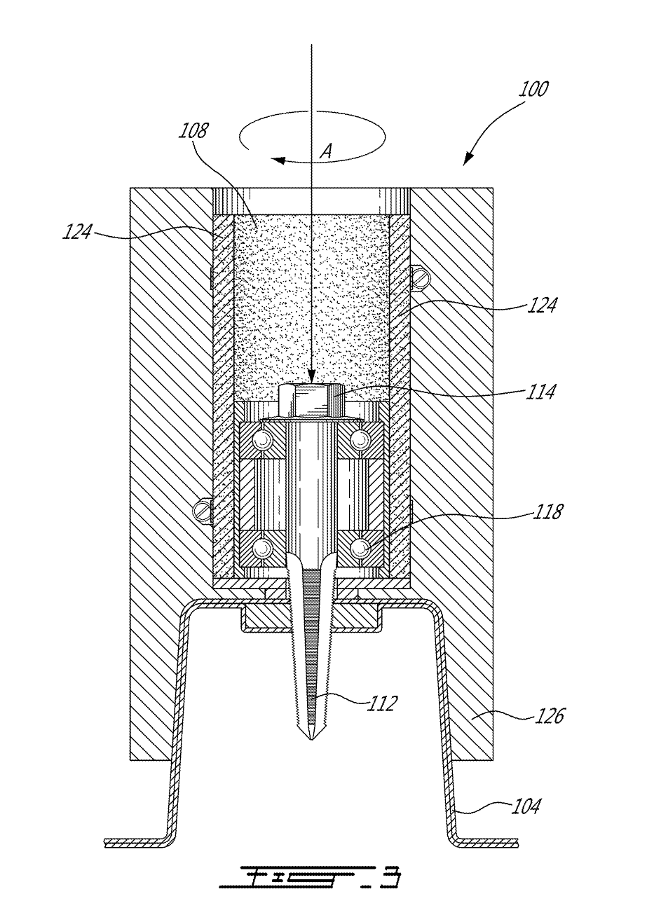

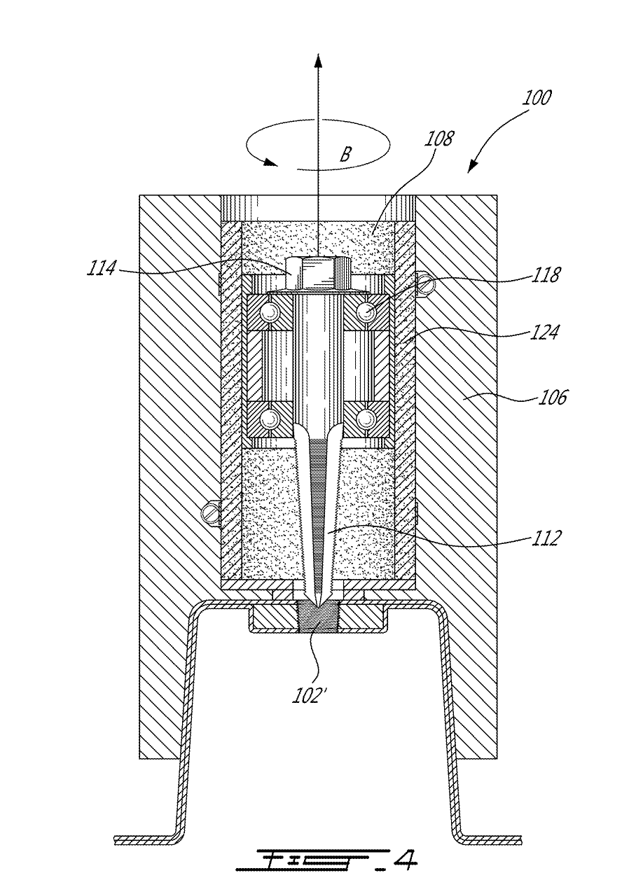

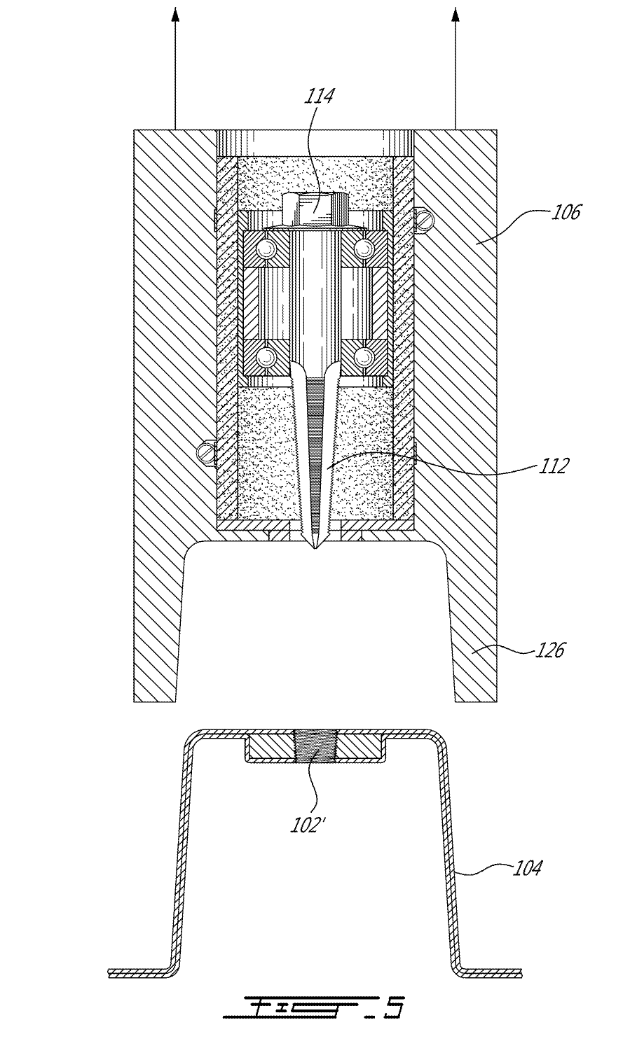

In operation, the alignment portion 126 of the apparatus 100 is first aligned with and moved toward the structure 104 (FIG. 1), until engagement thereof (FIG. 2) to provide proper alignment between the cavity 108, and thus the tapping element 112 engaged therein to be aligned therewith, and the hole 102. The driving element 114 is then driven (e.g. via a hand or powered tool) to rotate the tapping element 112 (arrow A) in progressively tapping the hole 102 (FIG. 3). Upon completion of the tapping action, the driving element is driven in the opposite direction (arrow B in FIG. 4) to retract the tapping element 112 from the tapped hole 102′, and the apparatus 100 removed from engagement with the structure 104 (FIG. 5).

As depicted by FIGS. 1 to 5, upon driving the driving element 114, the tapping element 112 is driven to engage the hole 102 through the alignment portion 126 of the body 106 and thereby advance within the body's cavity 108 to maintain alignment with the hole 102. Given this arrangement, the apparatus 100 can provide for improved stability and alignment during operation, thus yielding a more accurate tapping of the hole, for example. Improved speed and efficiency may also be achieved, which may be of particular consequence where successive tapping is to be implemented on successive components in a manufacturing or assembly line.

For example, in the automotive industry, weld nuts or other such structures, which may be of a predetermined shape and size, are routinely tapped to provide for the immediate or downstream assembly of related parts and components. A specific example is the tapping of a weld nut associated with or otherwise defined in a bump stopper or the like. For example, the weld nut to be tapped may be encased within a complete body unit (CBU) frame protrusion or the like. To ensure a certain level of quality and reproducible results (e.g. to avoid over sizing the weld nut threads), all within a rigid and often fast paced time frame, the above described apparatus (a bump stopper tap alignment jig, in this specific example) may allow for greater tapping efficiency and reproducibility. In turn, this may result in a reduction of production lag times and possibly, reduction in workflow interruptions (e.g. assembly line stoppages), thus reducing overall manufacturing costs and improving overall product quality. In some aspects, embodiments of the herein described apparatus/accessory may allow for a mechanically assisted accurate tapping at a higher speed. Clearly, the apparatus as considered herein may readily be applied in other industries and/or for other applications where tapping efficiency, accuracy, and/or ease of implementation may be desired or advantageous.

Clearly, the apparatus disclosed herein can be constructed in different sizes and shapes, or of different materials, to facilitate cooperative engagement with different structures and/or components for tapping these structures or components, or again components integrally or structurally associated therewith, as will be readily appreciated by the skilled artisan. It will be further appreciated that while the above provides an example for the automotive industry, similar apparatus may be contemplated within the scope of the present disclosure for other applications, not necessarily limited to the manufacturing assembly industry, where tapping alignment, speed and/or accuracy may be required or desired.

It will further be appreciated that while the above is cast within the context of a self-contained apparatus, other embodiments may rather provide for a tapping accessory, wherein various elements of the apparatus are provided for use with an existing tap. For example, a tapping accessory kit may include body 106, having cavity 108 formed therein and optionally comprising a predefined engagement portion 126, and one or more coupling elements, such as bearing assembly 110 and linear bearing 124. These components could then be used to effectively couple an existing tap in longitudinal alignment within the cavity to be guided thereby in operation, thus providing for improved tapping efficiency, alignment and the like.

It will further be appreciated that while above provides of a driveable tapping element configured to be driven by a hand or powered socket tool or the like, other embodiments may rather allow for different driving engagements, as well as for the cooperative use of the herein described tapping apparatus and/or accessory with existing tools and devices.

While the present disclosure describes various exemplary embodiments, the disclosure is not so limited. To the contrary, the disclosure is intended to cover various modifications and equivalent arrangements included within the spirit and scope of the appended claims. The scope of the following claims is to be accorded the broadest interpretation so as to encompass all such modifications and equivalent structures and functions.

1. A tapping apparatus for tapping a hole defined within a structure, comprising:
a body defining a longitudinal cavity therein and having an alignment portion defined at an extremity thereof for engaging the structure to be tapped to align said cavity with the hole; and
a tap assembly comprising opposed tapping and driving elements engaged within said cavity to rotate in longitudinal alignment therewith and to be longitudinally guided thereby;
wherein, upon driving said driving element, said tapping element is driven to engage the hole through said alignment portion and thereby advance within said cavity via said engagement therewith to maintain alignment with the hole.

2. The tapping apparatus of claim 1, said tap assembly engaged within said cavity via one or more rotational bearings to rotate in longitudinal alignment therewith.

3. The tapping apparatus of claim 2, said rotational bearing comprising a sealed bearing.

4. The tapping apparatus of claim 3, said sealed bearing comprising a high-speed bearing.

5. The tapping apparatus of claim 1, said tap assembly engaged within said cavity via a linear bearing longitudinally guiding said tap assembly within said cavity.

6. The tapping apparatus of claim 5, said linear bearing comprising an oil less bearing.

7. The tapping apparatus of claim 1, said tapping assembly engaged within said cavity via a pair of longitudinally spaced apart rotational bearings housed within a housing longitudinally displaceable within said cavity.

8. The tapping apparatus of claim 7, said housing mounted within said cavity via a linear bearing.

9. The tapping apparatus of claim 1, for use with a preset structure of preset size and shape, said engagement portion shaped and sized for cooperative structural engagement with the preset structure in aligning said cavity with the hole.

10. The tapping apparatus of claim 9, the hole defined along a longitudinal axis of a protruding structure, said alignment portion comprising one or more engagement structures extending longitudinally from said body to engage the protruding structure in aligning said cavity with the longitudinal axis thereof.

11. The tapping structure of claim 10, said one or more engagement structures defining a cup-like structure for mating engagement with the protruding structure.

12. A tapping apparatus for tapping a hole defined within a structure, comprising:
a body defining a longitudinal cavity therein for longitudinal alignment with the hole; and
a tap assembly comprising a tapping element and an opposed driving element for rotationally driving same, and a coupling element coupling said tapping element within said cavity to rotate in longitudinal alignment therewith and to be longitudinally guided thereby in operation.

13. The apparatus of claim 12, said coupling element comprising one or more bearings.

14. The apparatus of claim 13, said one or more bearings comprising a rotational bearing and a linear bearing.

15. The apparatus of claim 14, said rotational bearing comprising two or more rotational bearings sealed within a housing, said housing longitudinally displaceable against said linear bearing.

16. The apparatus of claim 15, said linear bearing comprising an oil less bearing.

17. The apparatus of claim 12, said body further comprising an engagement portion for structurally engaging the structure in aligning said cavity, and said tap element coupled therein, with the hole.

18. The apparatus of claim 17, said engagement portion integrally formed within said body.

19. The apparatus of claim 17, for use with a preset structure of preset size and shape, said engagement portion sized and shaped for cooperative structural engagement with the preset structure in aligning said cavity with the hole.

20. The apparatus of claim 19, said engagement portion shaped and sized for mating engagement with the preset structure.

21. A tapping accessory for use with a drivable tap in tapping a hole defined within a structure, the accessory comprising:
a body defining a longitudinal cavity therein for longitudinal alignment with the hole, and
a coupling element for coupling said drivable tap within said cavity to rotate in longitudinal alignment therewith and to be longitudinally guided thereby in operation.

22. The tapping accessory of claim 21, said coupling element comprising one or more bearings.

23. The tapping accessory of claim 22, said one or more bearings comprising a rotational bearing and a linear bearing.

24. The tapping accessory of claim 23, said rotational bearing comprising two or more rotational bearings sealed within a housing, said housing longitudinally displaceable against said linear bearing.

25. The tapping accessory of claim 21, said body further comprising an engagement portion for structurally engaging the structure in aligning said cavity, and the tap once coupled therein, with the hole.
